(19) United States
(12) Patent Application Publication
(10) Pub. No.: US 2004/0157321 A1
(43) Pub. Date: Aug. 12, 2004

(54) Device consisting of a Watertight Compartment for obtaining Compost, Bio-gas and water, by Biochemical De-atomisation and molecular magnetics, through decomposition of organic-vegetable and mineral refuse

(76) Inventor: Alejandro Tomas, Barcelona (ES)

Correspondence Address: ALEJANDRO TOMAS, SARDENYA 100 BAJOS, BARCELONA, 08018, ES

(21) Appl. No.: 10/629,575

(22) Filed: Jul. 30, 2003

(30) Foreign Application Priority Data
Feb. 6, 2003 (ES) U200300392

(51) Int. Cl. C05F 11/08

(52) U.S. Cl. 435/290.1; 435/290.2

(57) ABSTRACT

Device consisting of a Watertight Compartment for obtaining Compost, Bio-gas and Water, by Biochemical De-atomisation and Molecular Magnetics, through decomposition of organic-vegetable and mineral refuse: Characterised by the Container for Composting (Watertight Compartment) having inner walls that, by means of the clayey-limy material that they are made of, produce a catalysis that accelerates the speed of reactions and transformations that take place in the treated material (pre-Compost mass). The clayey-limy material could be substituted by another similar and appropriate one depending on the characteristics of the matter (organic, vegetable, mineral) formed by the elements to be turned into Compost and their underlying residual parts (water and Bio-gas).

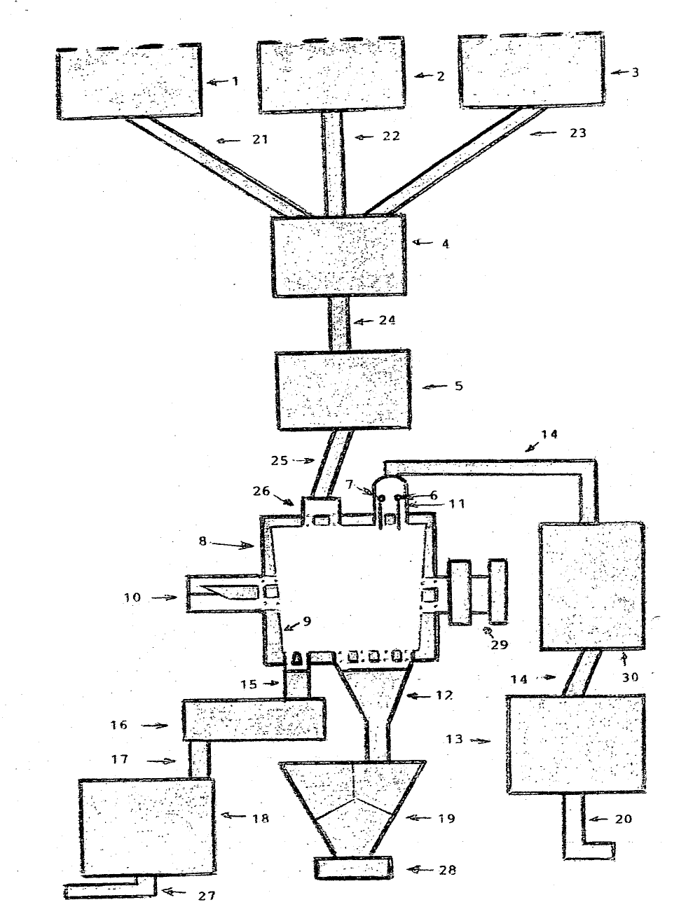

Device consisting of a Watertight Compartment for obtaining Compost, Bio-gas and Water, by Biochemical De-atomisation and Molecular Magnetics, through decomposition of organic-vegetable and mineral refuse: Characterised by the fact that the container referred to as Watertight Compartment is equipped with a mechanism to carry out angular movements in relation to its vertical lateral wall and the azimuth, plus other angular movements related to the diagonal of the base of the Watertight Compartment. The said diagonal, for optimum use of the Composter (Watertight Compartment) should be orientated, to a greater or lesser degree, with respect to the local meridian, giving rise by these angular (vertical and horizontal) movements to a better and higher performance in obtaining Compost and its surplus (Bio-gas and water), for taking greater advantage of the terrestrial magnetic field, that acts as a channelling and concentrating element of molecular alterations and of commutations and permutations of the superficial electrons of the basic atoms, components of the molecular chains that make up the organic, mineral and vegetable matter undergoing transformation (manure, Broiler chicken or cattle manure and animal remains, as well as the entire wide range of vegetable refuse and solid waste produced by towns).

High performance is not obtained with traditional aerobic fermentation methods (piles of organic and vegetable material) and the residues (mineral and vegetable) that accompany the residual Compost represent a distorting element; at the same time the gas generated by the Compost is not taken advantage of and neither is the residual water, that contaminates the ground on which the plant is built.

The maturing, decomposition and transformation stage is carried out inside the Watertight Compartment, a tank that can be large, as the amount does not affect the processing of the elements to be treated, such a process being referred to as; Biochemical De-atomisation and Molecular Magnetics.

### DESCRIPTION BELOW OF THE UTILITY MODEL HEREIN

With the method that we describe object of the Utility Model herein, handling, selection and shredding of the solid elements is carried out prior to putting them into the Watertight Compartment, having mixed them with the remains (dense liquid elements) of animal excrement.

By solid elements, we refer to those made up of vegetable refuse and solid waste produced by towns and industrial plants.

By liquid elements, we refer to those made up of remains of animal excrement (manure, Broiler chicken or cattle manure and other defecations or organic refuse of animal origin).

During the process for obtaining Compost, we will obtain another element that will contribute greatly to running the composting plant; this element is Bio-gas that is only accumulated in the Watertight Compartment and that we channel, by a system of regularisation of the pressure of surplus gas, through the corresponding purifying filter, towards a Bio-gas receiving and accumulating tank which, once pressurised, is suitable for commercial exploitation for obtaining calorific, electric (through combustion) energy, for heating/air-conditioning, electricity or sale of the gas.

During the same process for obtaining Compost, quality water is produced as a residual element, initially deposited on the bottom of the Watertight Compartment, and, in order to avoid excess dampness inside the Watertight Compartment, this water will be removed at timed intervals, after prior filtering (active charcoal and gravel filter) for subsequent industrial use, farming irrigation, fire-fighting networks, and watering public or domestic areas.

The system presents some highly innovative elements, methods and technologies that differ widely from traditional composting methods (by stacking, piles or storage in silo)

The process consists basically of 3 pieces of machinery that are:

Sifter and mixer of the solid elements and liquids to be treated, in a Watertight Compartment with all the corresponding elements that comprise it. And finally the storage tanks of Compost, Water and Bio-gas for their energy treatment.

Conditions relating to the weather, humidity, temperature, etc., do not have any effect on the method that we use, as the process is not carried out in the open air, but in a closed, watertight chamber, avoiding unpleasant smells and environmental pollution.

The process that we employ comprises a container of “geometric shapes” that is composed of contention walls made of non-metallic elements (that are, however, airtight and non-porous), lined inside by a clayey-limy material that acts as a Bio-container element for the maturing, fermentation and transformation phase of the matter placed in the Watertight Compartment.

At the top, next to the hatch through which elements coming from the shredder and mixer are entered, there is a “dome” (only operating when it detects the mixture of combustible gas) with its corresponding glycerine pressure gauge, the purpose of which is to receive the Bio-gas produced during transformation of the materials contained in the Watertight Compartment chamber. The said “dome” that acts as an excess-pressure valve only releases the Bio-gas that exceeds a specific bar pressure, such a pressure being vital for Biochemical De-atomisation and Molecular Magnetics processing. There is also a Thermograph that registers and regulates the appropriate temperature (that should be between 50° to 60° C.), regulating it by means of the “Heat exchanger” process, in addition incorporating a Hygrometer for controlling humidity.

At the top, there is an air and gas chamber of about a third of the total load to facilitate development of the anaerobic microorganisms, the metabolism of which controls increasing and blocking of the temperature of the Watertight Compartment.

A voltage stick is inserted through one side of the Watertight Compartment, which is used to stir and turn over the matter to be decomposed, and once this operation has been completed it is put back in its place, never allowing air from the outside atmosphere to enter the Watertight Compartment.

The above process of turning the entire mass will occur automatically every 15 days over the 90 to 120 days that the total process lasts. The said turning process will make the entire volume of mass (organic, vegetable, mineral) turn over completely between 6 to 8 times.

Residual water that accumulates at the bottom of the Watertight Compartment will only be released before unloading the Compost through the lower part of the Container (Watertight Compartment), filtering it and collecting it in the appropriate tank.

The Bio-gas is recovered through the Dome as the volume and quantity of it accumulated at the top of the Watertight Compartment exceeds the amount required to facilitate the correct process for Biochemical De-atomisation and Molecular Magnetics to the micro-organisms.

When carrying out unloading of the Compost (that will only retain 45% Humidity, the rest of its composition being an agreeably smelling, smooth, grainy, dark brownish grey mass, similar to vegetable humus), it will be seen that the volume has shrunk to half that of the material incorporated, the rest being Bio-gas and Water.

The qualitative composition (not quantitative), will contain the following materials: calcic organic matter, oxide organic matter, Carbon, residual ash, Nitrogen, Iron, Manganese, Zinc, Copper, Boron, Molybdenum, Aluminium, and Calcic Potassium and Manganese Oxide, depending on the elements initially entering the process.

### DESCRIPTION OF THE PARTS AND PIECES COMPRISING THE UTILITY MODEL HEREIN, FOR THEIR IDENTIFICATION IN THE ATTACHED DRAWING

1.—Organic vegetable refuse Container

2.—Manure, Broiler or Cattle dung Container

3.—Solid urban waste Container

4.—Mixer (component dosage measurer)

5.—Ash shredder

6.—Pressure gauge and maximum pressure or excess-pressure valve

7.—Thermograph and Hydrograph controllers of the Heat Exchanger

8.—Watertight Compartment outer walls

9.—Inside lining

10.—Mechanisms contained in the turning Stick

11.—Dome retaining Bio-gas output

12.—Compost unloading hatch

13.—Bio-gas accumulator

14.—Piping Bio-gas from the Dome to the Accumulator

15.—Discharging residual water from the Watertight Compartment

16.—Residual water filter

17.—Piping filtered water

18.—Water receiving and accumulating tank

19.—Compost receiving and accumulating tank

20.—Piping Bio-gas to be used

21.—Piping from Container to Mixer (vegetable refuse)

22.—Piping from Container to Mixer (manure, etc)

23.—Piping from Container to Mixer (solid urban waste)

24.—Piping mixed matter to the Shredder

25.—Piping mixed, shredded matter to the Watertight Compartment

26.—Hatch for entering material into the Watertight Compartment

27.—Piping water to be used

28.—Outlet hatch, for packaging Compost.

29.—Heat exchanger

30.—Bio-gas purifying filter

### DESCRIPTION OF THE SET OF ELEMENTS THAT MAKE UP THE VARIOUS PARTS OF THE UTILITY MODEL HEREIN

The plant described above is comprised of the following items:

The container of organic vegetable refuse (1), that contains both the latter and fragments, whatever their origin, as long as organic-vegetable; the next container (2) contains manure, cattle dung, Broiler chicken dung, etc., as well as animal remains; and, finally, the third container (3), contains solid urban waste.

The components of the three containers in question (1,2, and 3), are transported via pipelines (21, 22, and 23) to the mixer (4) that doses them according to quality and composition of the elements contained in the three above-mentioned containers.

Via conduit (24), the previously obtained mixture is placed in the shredder (5) with the aim of obtaining an already shredded compound before entering into the composting Watertight Compartment (8), through the hatch (26)

The Watertight Compartment (8) is comprised of an “irregularly shaped container”, with a base and cover of different sizes in order to facilitate unloading, its walls being made of non-metallic elements, lined inside (9) with a clayey-limy material: orientation in degrees in relation to the azimuth and meridians is very important, as these graduations accelerate and increase the maturing, fermentation and transformation phase and entire process of the matter that is placed in the Watertight Compartment (8)

During the composting stage, gases are produced by the effect of the anaerobic micro-organisms that are stored in an air chamber that is formed at the top of the Watertight Compartment (8); in this upper part the “Gas recovering Dome” is housed, containing the gauge and maximum pressure valve or pressostat (6) that regulates the amount of gas that can be extracted, without causing any alteration in the Biochemical De-atomisation and Molecular Magnetics process that takes place inside the Watertight Compartment (8).

The Thermograph and Hydrograph are inside the said Dome (11) and they control the Heat Exchanger so that the internal temperature of the mass in Composting phase does not exceed 50°-60° degrees Celsius.

The entire Composting process lasts between 90 and 120 days, whatever the weather (temperature, humidity, etc.). During the whole length of the process, the mass contained in the Watertight Compartment (8) should be turned over every 15 days, by inserting the “Turning Stick” (10). The contained matter undergoing transformation into Compost is completely turned around 6 or 8 times by this Stick, in order to achieve a perfect phase of the anaerobic microbial action process and perfect, uniform contact of all parts of the mass (organic-vegetable-mineral), with the clayey-limy walls (9) that comprise the inside of the Watertight Compartment (8).

Through conduit (14), the Bio-gas generated and captured by the Dome (11) is piped towards the Bio-gas Accumulator tank (13) after passing through the purifying filter (30), from which it will be piped through conduit (20) to produce and subsequently commercially exploit Bio-gas (electric energy, standard tap water, cold/heat, etc)

Water accumulates in the lower part of the Watertight Compartment (8), and, before opening the unloading hatch (12) and at timed intervals, it is discharged through pipe (12) passing through the Filter (16) made of active charcoal and gravel. Once it has been filtered, the water is piped through conduit (17) to the storage tank (18) for its subsequent use.

Finally, and after a minimum period of 90 to 120 days has lapsed, the unloading hatch (12) will be opened to discharge a lump of completely reprocessed Compost suitable for use as totally ecological farming fertilizer. Such Compost is stored in tank (19) for subsequent packaging and sale.

1.- Device consisting of a Watertight Compartment for obtaining Compost, Bio-gas and Water, by Biochemical De-atomisation and Molecular Magnetics, through decomposition of organic-vegetable and mineral refuse: Characterised by the Container for Composting (Watertight Compartment) having inner walls that, by means of the clayey-limy material that they are made of, develops a catalysis that accelerates the speed of reactions and transformations that take place in the treated material (pre-Compost mass). The clayey-limy material could be substituted by another similar and appropriate one depending on the characteristics of the material (organic, vegetable, mineral) formed by the elements to be turned into Compost and their underlying residual parts (water and Bio-gas).

2.- Device consisting of a Watertight Compartment for obtaining Compost, Bio-gas and Water, by Biochemical De-atomisation and Molecular Magnetics, through decomposition of organic-vegetable and mineral refuse: Characterised by the fact that the container referred to as Watertight Compartment is equipped with a mechanism to carry out angular movements in relation to its vertical lateral wall and the azimuth, plus other angular movements related to the diagonal of the base of the Watertight Compartment. The said diagonal, for optimum use of the composter (watertight compartment) should be orientated, to a greater or lesser degree, with respect to the local meridian, giving rise by these angular (vertical and horizontal) movements to a better and higher performance in obtaining compost and its surplus (Bio-gas and water), for taking greater advantage of the terrestrial magnetic field, that acts as a channelling and concentrating elements of molecular alterations and of commutations and permutations of the superficial electrons of the basic atoms, components of the molecular chains that make up the organic, mineral and vegetable material undergoing transformation (manure, Broiler chicken or cattle manure and animal remains, as well as the entire wide range of vegetable refuse and solid waste produced by towns).
